(19) United States
(12) Patent Application Publication
(10) Pub. No.: US 2006/0169051 A1
(43) Pub. Date: Aug. 3, 2006

(54) Method to specify acceptable surface appearance of a coated article

(76) Inventors: David H. Alman, Royal Oak, MI (US); Michael R. Koerner, Bloomfield Hills, MI (US); Jennifer H. Van Mullekom, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/332,062

(22) Filed: Jan. 13, 2006

Related U.S. Application Data
(60) Provisional application No. 60/643,531, filed on Jan. 13, 2005.

(51) Int. Cl. G01B 11/16

(52) U.S. Cl. 73/762

(57) ABSTRACT

Disclosed herein is a method for selecting and specifying an appearance of a surface of a coated article, such as an automobile or truck body.

### CROSS-REFERENCE TO RELATED APPLICATION

This application claims priority under 35 U.S.C. §119 from U.S. Provisional Application Ser. No. 60/643,531 (filed on Jan. 13, 2005), which is incorporated by reference herein as if fully set forth.

### FIELD OF THE INVENTION

This invention is related to a method for selecting and specifying an acceptable appearance of a surface of a coated article, in particular, coated surfaces of a vehicle, such as, an automobile or truck body.

### DESCRIPTION OF THE RELATED ART

Instrumental measurements of the appearance of a coating does not necessarily relate to human perceived appearance of a coating, particularly on a vehicle. This makes it difficult for a coatings manufacturer to set instrument based specifications for the coatings used by OEM (original equipment manufacturer) of vehicles and to set specifications for processes used to apply such coatings. It would be desirable to rescale instrumental measurements in a way that more directly relates to the human perceived appearance of a coating on a vehicle.

Scales have been developed based on measured values from various instruments with the intent that these measured values should correlate to human perceived appearance. These scales were developed using limited sets of sample panels and are usually correlated to a single scale of human perceived appearance. Typically, such scales were later found to be incomplete or inappropriate for new appearance textures and for final appearance and did not correlate to an acceptable human perceived appearance. Statistical Process Control (SPC) was used solely on instrumental measured values but the results did not correlate with the overall assessment of human perceived appearance.

Typically, appearance specifications are developed by determining a transfer function between instrumental appearance measurements and human perceived appearance; typically, a visual hedonic uni-dimensional scale rating (worst to best) is used on small sets of sample. Such specifications often fail when new samples have ratings that are inconsistent with human perceived appearance. For example, two samples with the same rating can have a very different human perceived appearance or a sample with an acceptable rating has an unacceptable human perceived appearance.

It would be desirable to have a method that utilizes diverse appearance samples, allows for multiple dimensions of human perceived appearance differences and develops a predictive transfer function between measured instrumental values and values of human perceived appearance so that there is consistent agreement between instrumental values and acceptable values of human perceived appearance.

### SUMMARY OF THE INVENTION

This invention is directed to a method for specifying the surface appearance of a coated substrate comprising the steps:
(1) preparing a group of samples of coated substrates using a variety of coating compositions and a range of varied process application conditions to provide for substrates having coated surfaces with varying appearances;
(2) measuring at least two different appearance characteristic values of each sample using appearance assessment instruments;
(3) selecting from the group of samples, selected samples that cover the full range of coating surface appearance formed by the varied range of coating compositions and process application conditions;
(4) determining from the appearance characteristic values of the selected samples, human visual perception difference data using MDS (Multi-Dimensional Scaling) and forming spatial organization of the data describing the human visual perception differences and from the spatial organization of the data determining an optimum number of visual perception dimensions required to describe the surface appearance;
(5) relating the optimum number of visual perception dimensions to the measured appearance characteristic values of the selected samples and predicting perception data values there-from; and
(6) setting acceptable appearance characteristic values and process performance requirements to achieve such values in units of multi-dimensional perception space for a coated substrate.

Optionally, the method also provides for input from a customer of coating compositions, such as, an OEM vehicle manufacturer, to provide appearance preference values acceptable to the customer, such that a supplier of coating compositions can provide coating compositions to the customer that are acceptable to the customer without any modification.

### BRIEF DESCRIPTION OF THE DRAWINGS

FIG. 1. Fitted v. actual preference score using a conventional unidimensional appearance rating.

FIG. 2. Contour plot of predicted preference score as functions of PC1 and PC2 for a polynomial model of preference.

### DETAILED DESCRIPTION OF THE INVENTION

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both preceded by the word “about.” In this manner, slight variations above and below the stated ranges can be used to achieve substantially the same results as values within the ranges. Also, the disclosure of these ranges is intended as a continuous range including every value between the minimum and maximum values.

All patents, patent applications and publications referred to herein are incorporated by reference in their entirety.

The novel method of this invention relates human visual perception data to instrumental measurements and is utilized to interpret the relevance of various measured scales and to computationally rescale instrumental measurements in a way that more correctly matches human perceived appearance of coated substrates. This method can be used to set specifications for coating compositions and the application thereof that are both simple to compute and are meaningful to end use customers.

Definition of terms used herein are as follows:

“Appearance assessment instruments” means instruments designed to measure physical or optical properties of a coating sample that can be related to the human visual appearance of the sample. An example of a physical appearance assessment measurement instrument is a stylus profilometer which measures displacement as a function of position that can be related to roughness or orange peel texture appearance of the surface of a coating. Examples of optical appearance assessment instrument include glossmeters and distinctness-of-reflected-image meters that measure optical characteristics of light reflected from the surface of a coating sample.

“Appearance surface characteristic values” are the properties measured by an appearance assessment instrument or scale values derived from the property measurements that can be related to human visual appearance response.

“Human visual perception difference data” means the results of experiments to quantify the dissimilarity of appearance of coatings samples as perceived by human observers.

“Multi-dimensional scaling” (MDS) means methods to represent the relationships between objects in a multi-dimensional space such that the distances between objects are good approximations to the similarities or dissimilarities of the objects. (If, on a relative scale, higher numbers represent objects that are more similar then the data set is expressed as similarities. Conversely, if higher numbers represent objects that are less similar, the data set is expressed as dissimilarities.)

Descriptions of MDS are provided in the following references:
Susan S. Schiffman, M. Lance Reynolds, Forrest W. Young, Introduction to Multidimensional Scaling, Academic Press, New York, 1981.
Trevor F. Cox, Michael A. A. Cox, Multidimensional Scaling, Second Edition, Chapman & Hall, New York, 2001.

“Multi-dimensional perception space” means the representation of the human visual perception differences between objects in a low dimensional space.

“Procrustes Analysis” means statistical methods to most closely align one spatial configuration of object values to a second spatial configuration of object values through data transformation techniques. Procrustes Analysis methods are described in Trevor F. Cox, Michael A. A. Cox, Multidimensional Scaling, Second Edition, Chapman & Hall, New York, 2001, Chapter 5, pp 123-140.

“Principal Component Analysis” means statistical methods to reduce a set of correlated multivariate measurements to a smaller set of uncorrelated variables that represent most of the variance in the original set.

The method of this invention has six primary steps.

In the first step, samples of coated substrates are prepared that cover the range of coating composition products and/or process variations and that provide for a variety of coating surface appearance. Designed experiments in coating formulation, application and substrate variables provide coated samples with varying appearance characteristics. These designed experiments provide samples with diverse surface appearances associated with a vehicle-coating product and utilize a range of substrates, coating formulation and application variables that generate surface appearance performance in the range of practical, commercial practice conditions. Impractical, ideal conditions as well as worst case conditions are avoided so that the results are in the range of commercial practice.

Design of Experiments (DOE) methods are applied to develop experiments with continuous and discrete variables with a few levels of each variable (usually 2 or 3 levels) using factorial, fractional factorial, response surface or other DOE methods. Surface coating appearance depends on the properties of multiple layers of the coating system. Accordingly, the DOEs utilize variations in substrate types, base coat coating types, clear coat coating types or composition variations within these coatings. Application conditions can be varied to apply the coating under wet or dry spray conditions. Wet conditions results in low atomization of the spray droplets (large droplet size distribution) in the material transport from spray gun to vehicle surface and dry conditions result in high atomization (small droplet size distribution). There are a number of alternative variables affecting the spray atomization, which can be used to create wet and dry spray application variation. Application and bake in the vertical or horizontal position is a significant factor in determining surface appearance characteristics of coating products. Vertical application usually results in an appearance of greater texture or orange peel than horizontal application of a coating. At a minimum, the application DOE variables should explore wet/dry and vertical/horizontal variations.

In the second step of the novel method, appearance characteristic values of each of the samples that were prepared are measured. At least two different appearance characteristics must be measured to provide meaningful data. For example, gloss, DOI (distinctness of image) and profilometry can be measured using conventional measuring instruments and techniques. One preferred instrument that is used is a wavescan instrument that measures surface structure characteristics at varying spatial wavelengths. A preferred instrument is Byk WaveScan instrument manufactured Byk-Gardner USA, located in Columbia, Md. This instrument filters wavescan data into six characteristic length scales denoted as dullness and wave structure A through E (du, Wa, Wb, Wc, Wd, We). Dullness corresponds to the scattering of near specular light. Wa corresponds to structures in the 0.1 to 0.3 mm length scale. Wb covers the 0.3 to 1 mm lengths. Wc covers the 1 to 3 mm lengths. Wd covers the 3 to 10 mm lengths. We covers the 10 to 30 mm lengths. For each of these values, a higher value means that there is more structure (or roughness) at that length scale. Lower values correspond to less texture while higher values correspond to more roughness. The appearance characteristic values for each of the samples of coated substrates, preferably, the wave scan values, are then plotted on a chart or charts.

In the third step of the method of this invention, samples of the coated substrates are selected from entire group of samples of coated substrates that have been prepared resulting in a group of selected samples that cover the full range of coating surface appearance that were formed by the various process application conditions. This can be accomplished by using, for example, Byk Wavescan measurements (du, Wa, Wb, Wc, Wd, We), which are inputs to a statistical clustering algorithm, which classifies the samples into clusters of similar measurements. The Byk Wavescan values for a sample form what can be termed a “structure spectrum” that shows the contribution of each component measurement at varying spatial wavelength. Cluster analysis assigns samples to cluster groups based on similarity of multivariate measurements of the samples. The multivariate measurements are the Byk WaveScan components. Distances between samples and clusters can be calculated in many ways. Preferably, a k-means cluster algorithm is used which minimizes the within cluster variance of the multivariate sample measurements for an assumed number of clusters (k). For example, k samples are selected for a visual perception experiment from a large sample set such that the selected samples cover as broad a range of sample characteristics as possible. The cluster analysis yields k clusters of samples with similar characteristics. By selecting one sample from each cluster, the appearance surface characteristic value diversity of samples are maximized in a small sample set selected from the original, larger sample set.

The fourth step of the process of this invention is a critical step wherein a determination is made from the appearance characteristic values of the selected samples of human perception difference data using Multi-Dimensional Scaling and forming spatial organization of the data to determine an optimum number of visual perception dimensions that are required to describe surface appearance.

A visual experiment is designed to provide a practical viewing environment for the samples. A preferred method is to use a balanced incomplete block (BIB) design to present samples in groups for visual judgment of similarity/dissimilarity of pairs of sample. The balanced incomplete block design presents a subset of all combinations of samples. For example, there are 560 combinations of 16 samples in groups of 3. One BIB design for 16 samples uses a balanced selection of 80 combinations or blocks of 3. The 3-sample sets are presented in turn to an observer who is asked to judge which sample pair is most similar in appearance and which sample pair is most dissimilar. Analysis of the observer's responses provides a scale of dissimilarity of all sample pairs. The experiment can be repeated with multiple observers to determine the variability of human appearance perception or to take a mean of human visual perception differences over a group of observers.

The similarity data is analyzed by a Multi-Dimensional Scaling (MDS) statistical method to determine the number of perception dimensions and the scale values of the samples on these dimensions. A matrix of similarities for all combinations of samples is the input data for MDS. MDS uses an iterative algorithm to find a configuration of sample data points in a space such that the distances between sample points in the space approximates the similarities between samples. The process is repeated for spaces with one, two, three and more dimensions. A stress value is calculated for each space to assess the residual error between the spatial configuration distances and the similarities. Stress decreases with increasing number of dimensions. A plot of stress versus dimensionality will often show an “elbow” at the number of dimensions that best describes the similarity data. Beyond this elbow there is diminishing value in explanation of the similarity data. Usually a few dimensions will provide an explanatory mapping of the similarity data. The sample data points can be plotted in the MDS dimensions to visualize distance relationships between samples.

In step five of the method, a transfer function between the appearance characteristic measurements and the MDS perception space is developed so that the perception scale values can be estimated by instrumental measurement. This is accomplished by using the results of principal components analysis of the appearance surface characteristic values as a reference data set in a Procrustes analysis to align the MDS and principal component spaces.

The dimensionality of the measured characteristics can be reduced by applying principal components analysis (PCA) which is a transfer function which preserves most of the variation in a set of multivariate measurement data in a set with fewer dimensions. Consider the Wavescan sample data with six measurement dimensions. There can be considerable correlation between measurement dimensions. For example, Wc values can be correlated with Wb and Wd scale values in a sample set since their wavelength ranges are adjacent. The correlations between scale values indicate that the six measurement scales are not independent and therefore, some of the variation in the data is redundant. PCA attempts to find a set of fewer dimensions that is uncorrelated and preserves most of the variation in the original data set. The original six dimensions are transformed to a new first principal component dimension that is the vector with maximum variance through the original six-dimension data. A second principal component vector, orthogonal to the first vector, is found that maximizes the remaining variance associated with the second principal component dimension and so on for principal components 3, 4, 5, 6. When there are strong correlations in the original dimensions only a few principal components are required to explain most of the variation in the sample set. In a pilot experiment, 90% of the variation in the six Wavescan measurements can be represented with two principal components.

A second transfer function is developed to align the measurement principal component dimensions to the MDS perception space using Procrustes analysis. The appearance surface characteristic values are represented by the principal components of these measurements. The human visual perception difference data are represented by the MDS scale values. In the event the same number of dimensions for the PCA and MDS mappings are chosen, the orientations of the mappings may not align and thus, interpretation of the MDS scales in terms of the PCA components may be difficult. Any dilation, translation, reflection, or rotation of the MDS perception map will preserve the relative distances between samples. Procrustes Analysis finds a transformation of one configuration map that minimizes differences with a second configuration map. Thus, Procrustes Analysis is used to transform (by dilation, rotation, reflection and rotation) the MDS perception map of the samples to the PCA map of the samples. The end result is that the combination of the PCA transfer function with the Procrustes analysis transfer function allows the human visual perception difference data to be estimated from the appearance surface characteristic values. Correlation of the principal component dimensions with the Procrustes transformations of the MDS perception map dimensions verifies that the PC dimensions preserve the sample human visual perception difference data. Although the process was described for the case with equal dimensions in the MDS and PCA maps, this is not required. For example, it would be possible to perform a Procrustes Analysis to map a 2-dimension MDS perception space onto a 3-dimension PCA space.

The combination of the PCA transfer function with the Procrustes Analysis transfer function is called a MDS transfer function.

In step six of the novel method, acceptable appearance characteristic values and process performance requirements to achieve such values are set in units of the multi-dimension perception space.

Visual judgments of sample preference are obtained. One method for preference rating is to ask an observer to place the samples in rank order from least to most preferred appearance. Another method is to use a balanced incomplete block design to compare small groups of samples for visual preference. For example, a BIB design could be used to present 16 samples in 80 blocks of 3. The observer is asked to choose the least and most preferred sample in each set. Analysis of the observer responses over the 80 blocks provides scale values of visual appearance preference.

Preference scores associated with the samples can be mapped in the multi-dimension perception space. For example, a preference score could be represented as a third dimension for samples with a two-dimension MDS map. The visual preference scale values for the test samples are mapped onto the MDS space to visualize the locations of loci of preferred surface appearance. Separate loci may be required for coatings prepared under different processing conditions, such as, horizontal and vertical vehicle surfaces. Target positions and specification limits in the MDS space are then determined such that samples within the limits provide preferred surface appearance.

Alternatively, the visual preference scores can be related to the MDS perception space through another transfer function so that preference scores can be calculated. A mathematical relationship between preference scores and MDS space dimensions is fitted. For example, a polynomial model of preference score as a function of MDS perception space dimensions could be fit.

Optionally and preferably, the customer of coating compositions, the OEM vehicle manufacturer, provides specification limits in the MDS perception space or appearance preference values to the coating manufacturer so that coating compositions and process conditions are provided that meet these requirements.

New test samples of coated substrates are evaluated by measurement of appearance surface characteristic values. The MDS transfer function converts the appearance surface characteristic values to MDS scale values for comparison to target and specification limits in perception space. Alternatively, a second transfer function computes preference scores from the MDS perception and allows the setting of appearance tolerances in preference units.

The novel process of this invention will make it possible to communicate and utilize the methodology with coating composition OEM customers, and coating competitors so that new scales can be established, and those scales are used to set customer specifications. It may be possible for appearance instrument manufacturers to license the scales produced utilizing the novel method and to incorporate the scales in their instruments. This would provide an improvement and benefit to the industry (instrument manufacturers, coatings suppliers and OEM coatings customers), resulting from a specification more directly tied to end use customer perception.

The present invention is further defined in the following Example. It should be understood that this Example is given by way of illustration only.

From the above discussion and this Example, one skilled in the art can ascertain the essential characteristics of this invention, and without departing from the spirit and scope thereof, can make various changes and modifications of the invention to adapt it to various uses and conditions. As a result, the present invention is not limited by the illustrative examples set forth herein below, but rather is defined by the claims contained herein below.

### EXAMPLE

Panels were coated using the following three different automotive coatings systems, i.e., solvent borne, water borne and powder coatings:

A solvent borne base coat is applied over three different substrates, (1) a steel substrate coated with a conventional E-Coat primer (electrodeposition coating primer), (2) steel substrate coated with a coil coating primer and (3) a steel substrate coated with a primer coating. Each of these substrates is coated with a different combination of base coat/clear coat applications. A base coat and clear coat were both applied under normal conditions to each of the above three substrates. Another set of panels was prepared in which the base coat was applied to a dry condition and the clear coat to a near normal condition; in a third, a base coat was applied under normal conditions and the clear coat under dry conditions; in a fourth, the base coat was applied wet and the clear coat under normal conditions and in a fifth, the base coat was applied normal conditions and the clear coat applied wet. A duplicate of each set of panels is prepared and flash dried and baked in two different positions, i.e., horizontal and vertical positions where the gravity effects are oriented differently during ambient flash-off, drying, and baked cure operations.

A water borne base coat is applied in a similar manner to the above described various substrates and then a clear topcoat is applied. The water borne base coat is applied under high (e.g. 70% RH) and low (e.g. 55% RH) humidity conditions. Clear topcoats with different flow characteristics, e.g., polysilane containing clear coats or two component acrylic/isocyanate crosslinked clears, are applied at various film builds and flashed and baked in the horizontal and vertical positions.

A powder clear coat is similarly applied as the above topcoat to the above described various substrates. A water borne base coat is applied before application of the powder clear coat under normal conditions and then the panels are flashed and baked in the horizontal and vertical positions.

All of the above used a black base coat color. The samples were prepared on 12 inch by 12 inch steel substrates. The complete set had 74 samples exhibiting a wide range of surface appearance characteristics.

Du, Wa, Wb, Wc, Wd, and We scale values were measured on a Byk Wavescan DOI instrument at multiple locations with averaging. The wave scan values were input to a clustering statistical analysis. A k-means cluster analysis algorithm assigned the samples to 14 clusters based on similarity of the Byk WaveScan values. The 74 samples were arranged in groups by their cluster assignments to visually verify that the surface appearance of samples within clusters was similar. One sample from each cluster was chosen as representative of that cluster. Choosing samples from each cluster provided a wide range of surface appearances. A second sample was chosen in two of the clusters to provide a nearly replicate appearance to test the precision of the method. Table 1 lists the selected samples with identification codes A through P and Byk Wavescan values and a uni-dimensional appearance scale (Rating) derived from the Byk Wavescan scale values.

A visual experiment was conducted with the 16 samples selected for diversity and replication. A balanced incomplete block design with 80 blocks of three samples was used. In this design each sample is rated with every other sample in two replicates. Samples were presented in threes on an inclined surface so that an overhead fluorescent light could be seen reflected from the samples' surfaces. A pattern of alternating black and white bars was placed over the diffuser of the fluorescent luminaire to provide a reflected image with distinct edges between contrasting light and dark areas. Twenty observers took part in the visual experiment. Ten were paint technologists familiar with surface appearance evaluation and ten were not technologists. The observer was asked to judge the surface appearance of the three samples and identify which pair was most similar (rating value 2) and which pair was most dissimilar (rating value 0). The remaining pair was assigned a rating value of 1. Subsequent analysis indicated there was little difference between paint technologist and non-technologist ratings so the observer groups were pooled. The ratings for all twenty observers were accumulated to provide a measure of similarity of surface appearance. Table 2 shows the matrix of similarity scores for all combinations of samples A through P. The maximum and minimum possible similarity scores for this experiment were 80 and 0 and real scores were in the range 75 to 10 giving good discrimination between similar and dissimilar sample pairs. The program requires that the diagonal elements of the matrix be set to 0.

The similarity matrix is the input to a Multi-Dimensional Scaling algorithm to arrange the samples in a spatial configuration that minimizes the stress (residual error) between the similarity data and the spatial configuration for 1, 2, 3, 4, 5, 6, and 7 dimension spaces. Table 3 shows the stress values for spatial configurations of varying dimensionality. The stress data indicate diminishing improvement after the second or third dimension. The samples were arranged by their score values in the two and three-dimensional spaces for visual verification of the configurations. The first and second dimensions appeared to be related to texture roughness over all length dimensions and a contrast between short and long length texture roughness. A third dimension of the configuration could not be visually interpreted and so the two-dimension configuration was accepted for this experiment.

The Byk Wavescan du, Wa, Wb, Wc, Wd, and We data were input to a principal component analysis algorithm to identify uncorrelated principal components of the Byk data. Table 4 shows the variance associated with six principal component vectors and Table 5 shows the loading of the original Byk Wavescan scales on the first two principal component vectors. Two principal components (PC1, PC2) describe 89.7% of the variance in the six Byk scale values for this experiment. The Byk scale loading on PC1 indicates that all scale values of all lengths contribute to PC1. This can be interpreted as a roughness measure over all length scales. The Byk scale loading on PC2 shows a contrast between (du, Wa, and Wb) and (Wc, Wd, and We) which can be interpreted as a contrast between short and long length texture roughness.

A transfer function between Byk Wavescan values and multi-dimension perception space values is needed so that perception scores of new samples can be computed. Procrustes analysis was used to transform the two-dimension MDS perception configuration to align with the two-dimension principal component configuration by dilation, translation, reflection and rotation operations. This analysis provides a new two-dimension perception space that is well aligned with the principal component space. Table 6 lists the principal component and transformed MDS perception dimension values. There were strong correlations between the principal component and transformed MDS perception dimensions. PC1 and transformed MDS dimension 1 had a correlation of 0.816 and PC2 and transformed MDS perception dimension 2 had correlation of 0.883. Because of the high correlations, PC1 and PC2 were used as replacements for the transformed MDS dimensions in the tolerance setting step. Alternatively we could have chosen to use the correlation transformations to transfer PC components to units of transformed MDS space.

A matrix multiplication of the Byk Wavescan values (Vector B (6×1)) by the principal component matrix (matrix P (2×6)) is the transfer function between Byk scale values and the MDS perception space (vector M (2×1)) as shown in equation 1.
M=PB (1)

Optionally, a second transfer function between principal components and MDS dimensions could be included by a matrix multiplication with a correlation matrix (C (2×2)). In this case the transfer function would be given by equation 2.
M=CPB (2)

A second visual experiment was conducted to determine the visual appearance preference rating for the 16 selected samples. Twenty new observers (10 paint technologists, 10 not technologists) rated the samples under the same viewing conditions as the appearance perception experiment. The same balanced incomplete design of 80 blocks of 3 samples was used. The observer's task was to select the most preferred sample (rating=2) and least preferred sample (rating=0) as coatings for an automobile. The remaining sample received a preference rating of 1. The group preference scores were pooled since there were only minor differences between observer groups. The average preference scores are shown in table 6.

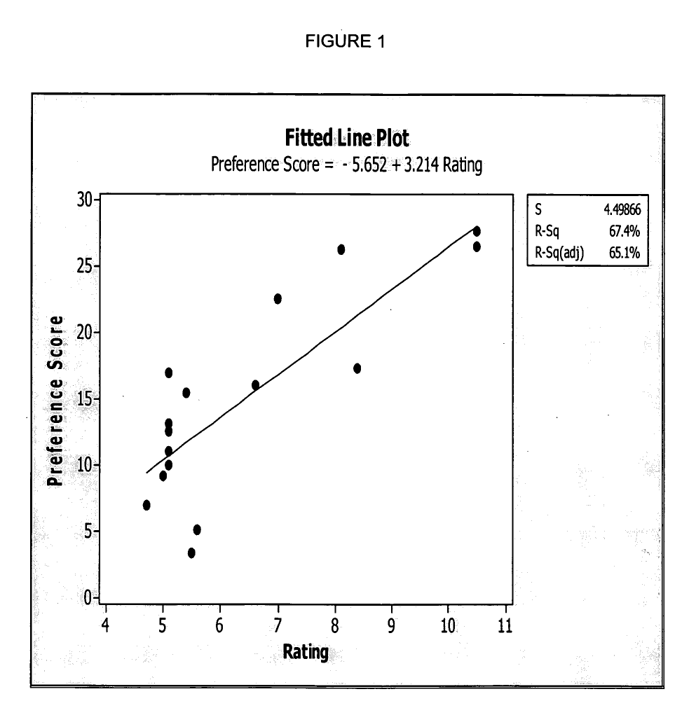

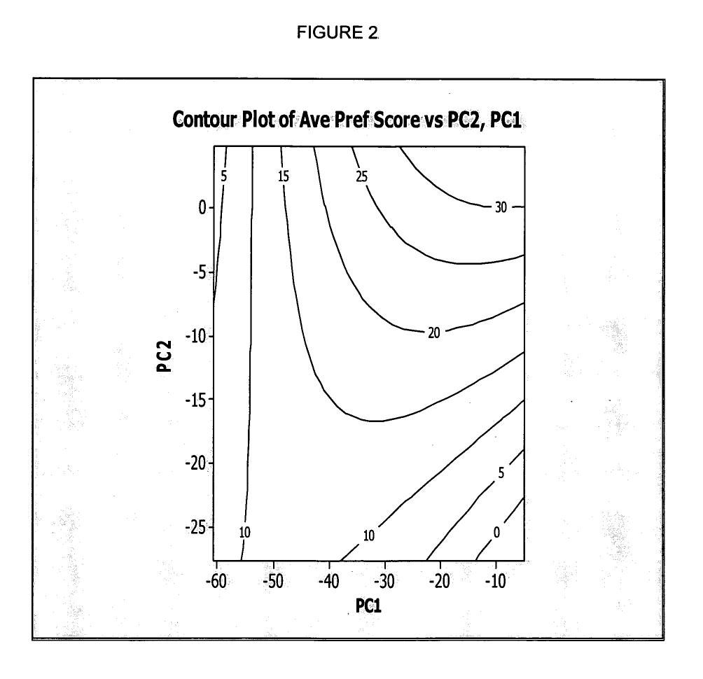

Two models were fit for preference scores. The first was a linear model using a unidimensional appearance rating provided in the Byk Wavescan (see Table 7 and FIG. 1). The second was a quadratic polynomial model using PC1 and PC2. The coefficient of multiple determination measures the variation explained by a model. The multidimensional model explains 84.1% of the preference variation compared to just 67.4% for the unidimensional rating model. FIG. 2 is a contour plot of preference score as functions of PC1 and PC2. The locus of highest preference is at high levels of PC1 and high levels of PC2. This region has low surface roughness over all Byk length scales (because the PC1 loadings on the Byk scale values are all negative, increasing roughness is associated with decreasing PC1). The desirable region has high PC2 values indicating that a positive contrast of long length components (Wc, Wd, We) over short length components (du, Wa, Wb) is desirable. Tolerances could be set to assure that new composition or application samples have preferred appearance. For example, setting tolerances of PC1>−40 and PC2>−10 would provide preference scores of approximately 20 and above. Alternatively the polynomial model between the multidimensional appearance dimensions (PC1, PC2) and the preference score can be used to set specifications in preference units. The polynomial model is given in equation 3.
Pref=29.1428−0.1753(PC1)+1.441(PC2)−0.0099(PC1*PC1)+0.0269(PC1*PC2) (3)
Captions for Tables and FIGS. 1 and 2.
Table and figure captions.

Table 1. Sample identification codes, Byk Wavescan values, principal component scores and rating values for the example experiment.

TABLE 1

| Panel | du | Wa | Wb | Wc | Wd | We | PC1 | PC2 | Rating |
|---|---|---|---|---|---|---|---|---|---|
| A | 1.8 | 5.4 | 20.9 | 34.6 | 26.6 | 9.6 | −44.5 | −21 | 5.1 |
| B | 2.6 | 8.4 | 20.6 | 28.9 | 28.7 | 12.7 | −44 | −17.8 | 5.4 |
| C | 1.1 | 9.9 | 33.8 | 15.6 | 11.8 | 8.3 | −38.5 | 4.8 | 8.1 |
| D | 3.4 | 2.6 | 11.6 | 32.3 | 30.4 | 16.7 | −39.3 | −27 | 5 |
| E | 1.3 | 5.8 | 19.4 | 32.7 | 28.9 | 8.9 | −43.5 | −21.8 | 5.1 |
| F | 1 | 0.5 | 1 | 0.7 | 5.4 | 11.6 | −5 | −2.7 | 10.5 |
| G | 19.2 | 29.5 | 31.5 | 30.5 | 23.8 | 7.8 | −60.6 | 1.1 | 5.5 |
| H | 1 | 5.6 | 23.2 | 20.8 | 16 | 7.8 | −34.4 | −6.9 | 7 |
| I | 2.6 | 3.6 | 16.1 | 35.7 | 32.7 | 11.8 | −44.2 | −27.7 | 4.7 |
| J | 1 | 1.4 | 9.8 | 18.1 | 23.9 | 8 | −26.4 | −17.6 | 6.6 |
| K | 1 | 1.2 | 2.5 | 2.3 | 6 | 9.5 | −7 | −2.8 | 10.5 |
| L | 2.4 | 3.7 | 11.9 | 28.1 | 33 | 15.6 | −38.5 | −25.8 | 5.1 |
| M | 3.8 | 7.4 | 23.8 | 34.1 | 27.2 | 10.2 | −47.5 | −18.5 | 5.1 |
| N | 15.5 | 28.7 | 25.9 | 29.3 | 24.1 | 9.4 | −55.9 | −2 | 5.6 |
| O | 1 | 6.7 | 17.3 | 6.8 | 17.6 | 14.5 | −25.8 | −2.6 | 8.4 |
| P | 1.9 | 5.7 | 26.4 | 33.5 | 33.6 | 14.9 | −50.9 | −21.7 | 5.1 |

Table 2. Matrix of visual appearance dissimilarity values for all pairs of the experiment samples.

TABLE 2

| Panel | A | B | C | D | E | F | G | H | I | J | K | L | M | N | O | P |
|---|---|---|---|---|---|---|---|---|---|---|---|---|---|---|---|---|
| A | 0 | | | | | | | | | | | | | | | |
| B | 58 | 0 | | | | | | | | | | | | | | |
| C | 16 | 34 | 0 | | | | | | | | | | | | | |
| D | 44 | 73 | 9 | 0 | | | | | | | | | | | | |
| E | 56 | 66 | 32 | 75 | 0 | | | | | | | | | | | |
| F | 27 | 25 | 72 | 14 | 34 | 0 | | | | | | | | | | |
| G | 47 | 31 | 22 | 29 | 48 | 13 | 0 | | | | | | | | | |
| H | 47 | 28 | 47 | 14 | 42 | 37 | 47 | 0 | | | | | | | | |
| I | 34 | 58 | 21 | 63 | 32 | 23 | 46 | 23 | 0 | | | | | | | |
| J | 58 | 63 | 30 | 65 | 44 | 32 | 23 | 43 | 64 | 0 | | | | | | |
| K | 28 | 38 | 67 | 12 | 16 | 74 | 10 | 52 | 12 | 33 | 0 | | | | | |
| L | 61 | 68 | 20 | 69 | 56 | 15 | 22 | 24 | 75 | 73 | 13 | 0 | | | | |
| M | 49 | 63 | 20 | 71 | 49 | 20 | 40 | 42 | 20 | 35 | 28 | 60 | 0 | | | |
| N | 60 | 59 | 18 | 30 | 46 | 13 | 56 | 63 | 56 | 44 | 12 | 38 | 52 | 0 | | |
| O | 14 | 35 | 36 | 14 | 10 | 42 | 45 | 47 | 20 | 48 | 54 | 28 | 47 | 22 | 0 | |
| P | 50 | 50 | 29 | 56 | 60 | 15 | 27 | 34 | 42 | 52 | 23 | 47 | 50 | 49 | 34 | 0 |

Table 3. Residual stress as function of the number of dimensions in the MDS perception space configuration.

TABLE 3

| Dimension | Stress-All |
|---|---|
| 1 | 0.33 |
| 2 | 0.20 |
| 3 | 0.14 |
| 4 | 0.10 |
| 5 | 0.07 |
| 6 | 0.05 |
| 7 | 0.04 |

Table 4. Variance proportion and cumulative variance proportion as functions of the number of principal components of the Byk Wavescan data.

TABLE 4

| PC | Variance | Cumulative |
|---|---|---|
| dimension | proportion | variance proportion |
| 1 | 0.687 | 0.687 |
| 2 | 0.21 | 0.897 |
| 3 | 0.069 | 0.966 |
| 4 | 0.024 | 0.990 |
| 5 | 0.008 | 0.998 |
| 6 | 0.002 | 1.000 |

Table 5. Loading values for the Byk Wavescan values on principal components PC1 and PC2.

TABLE 5

| Wavescan | PC1 Weight | PC2 Weight |
|---|---|---|
| du | −0.192 | 0.177 |
| Wa | −0.404 | 0.435 |
| Wb | −0.611 | 0.448 |
| Wc | −0.501 | −0.528 |
| Wd | −0.396 | −0.548 |
| We | −0.133 | −0.015 |

Table 6. Principal component values (PC1, PC2) and transformed MDS perception dimensions (MDS1, MDS2) after alignment with a Procrustes analysis and the average preference scores for twenty observers in the example experiment.

TABLE 6

| | | | | | Preference |
|---|---|---|---|---|---|
| Panel | PC1 | PC2 | MDS1 | MDS2 | Score |
| A | −44.5 | −21.0 | −0.211 | −0.034 | 12.6 |
| B | −44.0 | −17.8 | −0.011 | −0.109 | 15.5 |
| C | −38.5 | 4.8 | 0.303 | 0.098 | 26.3 |
| D | −39.3 | −27.0 | −0.055 | −0.234 | 9.2 |
| E | −43.5 | −21.8 | −0.132 | −0.133 | 13.1 |
| F | −5.0 | −2.7 | 0.353 | 0.068 | 26.5 |
| G | −60.6 | 1.1 | −0.282 | 0.231 | 3.4 |
| H | −34.4 | −6.9 | −0.048 | 0.234 | 22.6 |
| I | −44.2 | −27.7 | 0.121 | −0.252 | 7.0 |
| J | −26.4 | −17.6 | 0.107 | −0.116 | 16.1 |
| K | −7.0 | −2.8 | 0.244 | 0.195 | 27.7 |
| L | −38.5 | −25.8 | 0.027 | −0.225 | 10.0 |
| M | −47.5 | −18.5 | −0.152 | 0.019 | 17.0 |
| N | −55.9 | −2.0 | −0.237 | 0.079 | 5.1 |
| O | −25.8 | −2.6 | 0.090 | 0.254 | 17.3 |
| P | −50.9 | −21.7 | −0.118 | −0.075 | 11.1 |

Table 7. Fit preference score for the conventional unidimensional appearance rating.

TABLE 7

| | | | Fit |
|---|---|---|---|
| | | Preference | Preference |
| Panel | Rating | Score | Score |
| A | 5.1 | 12.6 | 10.7 |
| B | 5.4 | 15.5 | 11.7 |
| C | 8.1 | 26.3 | 20.4 |
| D | 5 | 9.2 | 10.4 |
| E | 5.1 | 13.1 | 10.7 |
| F | 10.5 | 26.5 | 28.1 |
| G | 5.5 | 3.4 | 12.0 |
| H | 7 | 22.6 | 16.8 |
| I | 4.7 | 7.0 | 9.5 |
| J | 6.6 | 16.1 | 15.6 |
| K | 10.5 | 27.7 | 28.1 |
| L | 5.1 | 10.0 | 10.7 |
| M | 5.1 | 17.0 | 10.7 |
| N | 5.6 | 5.1 | 12.3 |
| O | 8.4 | 17.3 | 21.3 |
| P | 5.1 | 11.1 | 10.7 |

FIG. 1. Fitted v. actual preference score using a conventional unidimensional appearance rating.

FIG. 2. Contour plot of predicted preference score as functions of PC1 and PC2 for a polynomial model of preference.

What is claimed is:

1. A method to specify the surface appearance of a coated substrate comprising the steps:
(1) preparing a group of samples of coated substrate using a variety of coating compositions or a range of variations of process application conditions to provide for a variety of coating surfaces appearances;
(2) measuring at least two different appearance characteristic values of each sample using appearance assessment instruments;
(3) selecting from the group of samples, samples that cover the full range of coating surface appearance formed by the range of coating compositions and process application conditions;
(4) determining from the appearance characteristic values of the selected samples, human visual perception differences data using Multi-Dimensional Scaling and forming spatial organization of the data describing the human visual perception differences and from the spatial organization of the data determining an optimum number of visual perception dimensions required to describe the surface appearance;
(5) relating the optimum number of visual perception dimensions to the measured appearance characteristic values of the selected samples and estimating perception data values there-from; and
(6) setting acceptable appearance characteristic values and process performance requirements to achieve such values in units of multi-dimensional perception space for a coated substrate.

2. The method of claim 1 wherein a customer's visual perceptions dimensions in the setting of acceptable appearance characteristic values are utilized in step (6).

3. The method of claim 1 in which appearance assessment instrument is a Wavescan devices using a spectrum of six components at varying spatial wavelengths.

4. The method of claim 3 wherein the Wavescan device spectrum comprises components du, Wa, Wb, Wc, Wd and We.

5. The method of claim 1 in which the Multi Dimensional Scaling is done using balanced incomplete block designs.

6. The method of claim 1 in which selecting the selected samples uses cluster analysis of the appearance characteristic values.

7. The method of claim 1 in which Procrustes analysis is used in step (5) to align measurement and perception data values.

8. The method of claim 1 used to set specifications for a coated substrate.

9. The method of claim 1 used to set specifications for a coating process.
